(19) United States
(12) Patent Application Publication
(10) Pub. No.: US 2006/0049301 A1
(43) Pub. Date: Mar. 9, 2006

(54) Solar-Powered Floatation Device for all types of vehicles (air, land and sea)

(76) Inventors: Victor Yek Yam, Manila (PH); Karen Joyce C. Yam, Manila (PH); Charmaine Jean Yam, Manila (PH)

Correspondence Address: Victor Yek Yam, 3315 Bataan St., Bacood, Sta. Mesa, Manila, 1008, PH

(21) Appl. No.: 10/936,011

(22) Filed: Sep. 8, 2004

(51) Int. Cl. B64B 1/20; B64C 17/00

(52) U.S. Cl. 244/5

(57) ABSTRACT

The device that we have invented is designed with the following components: 1. an array of solar cell panels to provide power 2. a computerized control panel, 3. a series of pre-arranged balloons or air bags 4. pump or compressor, storage tank, batteries and a pillow-shaped design body. The way the device works is that with power supplied by the solar cells the series of pumps shall pump helium gas from the tanks into a predetermined number of balloons distributed all throughout the vehicle. The number of balloons that shall be filled with helium are controlled by the onboard computer system. Once most of the balloons are filled, the buoyancy of the helium-filled balloons will reduce the weight of the vehicle corresponding to the number of balloons being inflated; the more balloons that are inflated, the lighter the vehicle becomes. To return to its normal weight, all the vehicle operator has to do is to reverse the pump to deflate the balloon and causing the return of the helium gas back to the tank. Batteries shall provide power for nighttime operation.

The Solar-Powered Floatation Device for all type of vehicles (air, sea and land), is a device powered by the sun's rays to automatically reduce the weight of any vehicle either designed for air, sea or land operation. The purpose of reducing the weight of any vehicle is to enable the described vehicle to fly in the air, skim on top of the water or ride along the open road at a very much reduced weight than its own actual weight, propelled forward only by the power of solar energy.

The Solar-Powered Floatation Device is composed of a specifically designed body fuselage that includes a series of solar panel cells attached to the roof of the fuselage, an array of pre-shaped balloon or balloons arranged strategically throughout the body of the fuselage, specially-designed air compressor, specially-made storage gas tank, lightweight storage battery and computer.

The Solar Powered Floatation Device operates on the same principle like any lighter-than-air balloon. When its balloons are fully inflated, the device and the vehicle become weightless, when its balloons are deflated, it returns to its original weight. The difference is that the device utilizes solar energy to control inflation and deflation of its balloons. With numerous balloons pre-arranged inside its fuselage body, the device can inflate or deflate any number of balloons thru its computer-controlled program. Using a specially-designed powerful mini-compressor to pump helium gas from a specially-made lightweight cylinder tank into the numerous balloons pre-positioned throughout its fuselage body, the vehicle becomes weightless. When the vehicle needs to return to its original weight, the compressor can reverse the process by sucking the helium gas from the balloons back into the cylinder storage tank.

The ability to control the number of balloons that can be inflated or deflated repeatedly allows the pilot/operator of the vehicle to adjust the weight of the vehicle as he desires, thus giving him complete control in the rise and fall of the vehicle as long as solar energy is available.

The special design of the vehicle fuselage is also of tremendous importance. The fuselage must be in the shape of a common pillow or rectangular shape, as will be shown in our drawing. Tests have proven that this shape is the most buoyant of all shapes. It is also important to point out that this shape allows the roof of the vehicle to accommodate the maximum layout of solar panel cells, thus giving the vehicle more than enough electrical energy to not only run the floatation device, but also enough energy to power several motor engines to propel it forward.

In summary, the Solar Powered Floatation Device, when installed inside a specially designed fuselage body, that is made of super strong lightweight material such as carbon fiber composite material, which are now widely available, can allow such a combination of a vehicle to defy gravity repeatedly without limit and to have controlled forward motion also without limit, also to carry passengers or cargoes without limit, based on the design of the vehicle, finally for it to fly to any destination without limit as long as solar energy is available.

The Solar Powered Floatation Device is designed to be versatile. It can be installed in vehicles designed for specific purposes, such as for flying, sea going or running on dry land. When it is for flying, the balloons inside the vehicle, when fully inflated, shall have rendered the vehicle totally weightless, the excess solar energy shall then turn on the electric power propellers to give it forward motion and the vehicle can then fly like any ordinary airplane. When it is designed for the sea, the balloons, when fully inflated, shall only allow the vehicle to float 3 or 4 feet above sea level. The excess solar energy shall then power the electric engine propellers to allow the vehicle to move forward just above the waves and to sail to any seaport without touching the water. When the vehicle is designed for land, the balloons, when fully inflated, shall make the weight of the vehicle only a fraction of its actual weight, thus making the vehicle less expensive to operate.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

There have been many attempts to make use of solar energy to achieve successful and economically-feasible human-controlled flight. Up to the present, no one has succeeded. With the price of oil rising daily, it is imperative that an alternative source of energy for transportation be found. The most abundant and free form of energy up to now remains to be solar energy. But advances in our current technology are still unable to make economically-feasible solar-powered human-controlled flight. Even today, a solar car remains to be bicycle-like contraption that does not offer many useful purposes other than for recreation. The problem has always been gravity—“weight” remains to be the biggest problem with any solar car prototype so far.

Today, airplanes and automobiles rely on brute power to overcome the “weight” problem. But brute power always comes with a price—it consumes a lot of energy. With the world's supply of oil dwindling, and oil prices rising, brute power is no longer an option.

The only other option to overcome gravity is using the balloon. For the past several hundred years, men had looked to the balloon as a means to defy gravity. The problem with the balloon is that it is very difficult to control. Up to the present, balloon flight remains to be unreliable.

If we can combine the uses of solar energy, balloon power and today's technological advances, we shall have found the solution to the problem, and indeed we now have.

We have discovered that in the swimming pool, a simple rectangular float can support much more weight than any other-shaped float. It is because of the principle of buoyancy. Now, if we use the same principle in a balloon, and make a vehicle shaped like a pillow, combined with the uses of today's super-strong and super-light carbon fiber material to build a fuselage, and instead of using a single balloon for dirigible uses, we use multiple pre-shaped and pre-arranged balloons, utilizing solar energy instead of gasoline, use lightweight reversible pumps to control helium gas, use lightweight electric motor as propulsion unit, then we shall have discovered that we have a safe, maneuverable solar-powered balloon vehicle.

There are many other solar-powered airship designs in the past, but most are cigar-shaped that have problem with solar panel cells not getting enough sunlight because they are facing the wrong direction. Others have problems controlling the rising and lowering of the vehicle because they are made of a single balloon.

Our design has solved these problems. Our pillow-shaped design allows the entire roof of the vehicle to be covered with solar cells, thus ensuring maximum absorption of sunlight during the day, guaranteeing more than enough solar energy for other uses. The use of multiple balloons, helium gas stored in cylinders, and reversible mini-pumps shall enable the vehicle to rise or lower itself anytime, anywhere it wants to without limitation.

A solar cell array orientation airship has been patented as U.S. Pat. No. 6,540,178, it is also using solar energy to power its flight, but its design does not allow it enough solar energy for its uses. Another solar powered airship is known from U.S. Pat. No. 5,518,205, it is composed of a pair of inflated hulls which are connected by forward and rear wings and from which a gondola is supported by extension wires. The problem is its design makes for poor aerodynamics, and limits its uses.

### BRIEF SUMMARY OF THE INVENTION

The Solar Powered Floatation Device was initially conceived to be used in a flying vehicle. But subsequent analysis revealed that it can also be used for land and sea travel. Of course different designs must be used for each mode of transportation, but still the same principle applies.

The use of a special design for the vehicle's fuselage, such as the rectangular pillow-shaped body, not only allows the entire roof of the vehicle to absorb the maximum of the sunlight it can accommodate during the day, but it is also very aerodynamic, allowing the vehicle to knife through the air without much air resistance. Its lower body also gives maximum buoyancy and stability to the vehicle. The multiple pre-shaped and pre-positioned balloons also give maximum safety to the passengers of the vehicle. Ordinary single balloon airships would crash to earth once it develops a leak. Our vehicle has multiple balloons, all of which are much smaller and therefore have a greater resiliency against its internal air pressure than any single big balloon. And even if leaks should develop, the rest of the multiple balloons shall be more than enough to keep the entire vehicle afloat for a long period of time, allowing repair to be done.

The multiple-balloon system contained in a specially designed fuselage body is an innovation unlike any other. It is a system where a preset number of balloons are inflated to achieve a certain weight. With today's computer advances, the computer can determine the appropriate number of balloons to be inflated with helium gas in order for the vehicle to rise to a certain height, and also the appropriate number of balloons to be deflated for the vehicle to lower itself to a certain level.

Excess solar energy is to be stored in a specially made lightweight storage battery for night-time operation.

It is foreseen that the Solar Powered Floatation Device shall usher in a period of new product development in the transportation industry, where the energy requirement is supplied by solar power. With the advent of the solar-powered flying vehicle, and with its ability to fly anywhere and land anywhere, a whole new way of life and doing business is open to us.

### DETAILED DESCRIPTION OF THE INVENTION

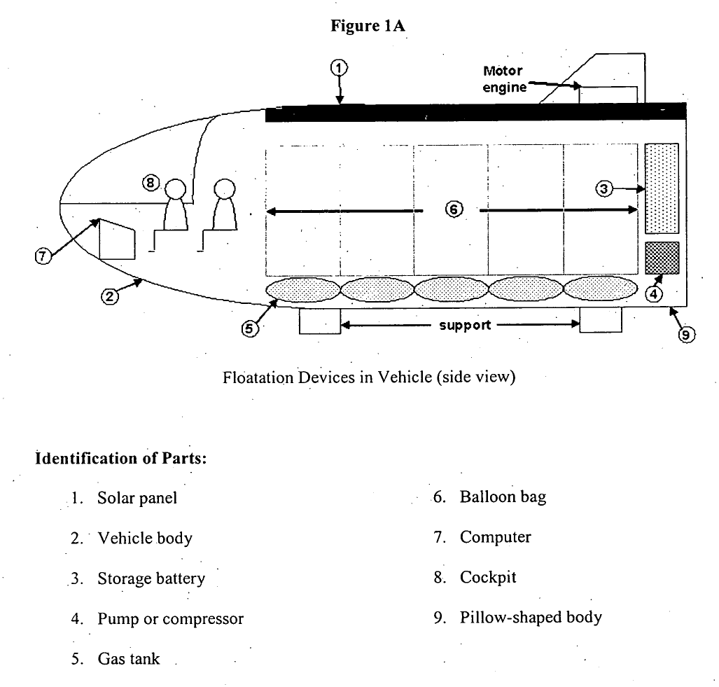

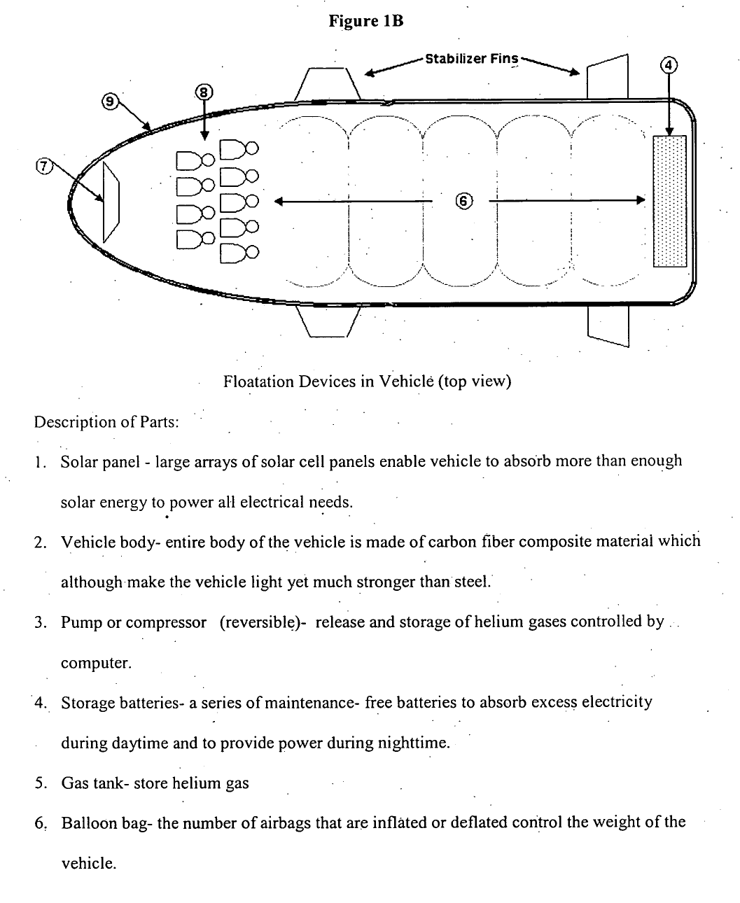

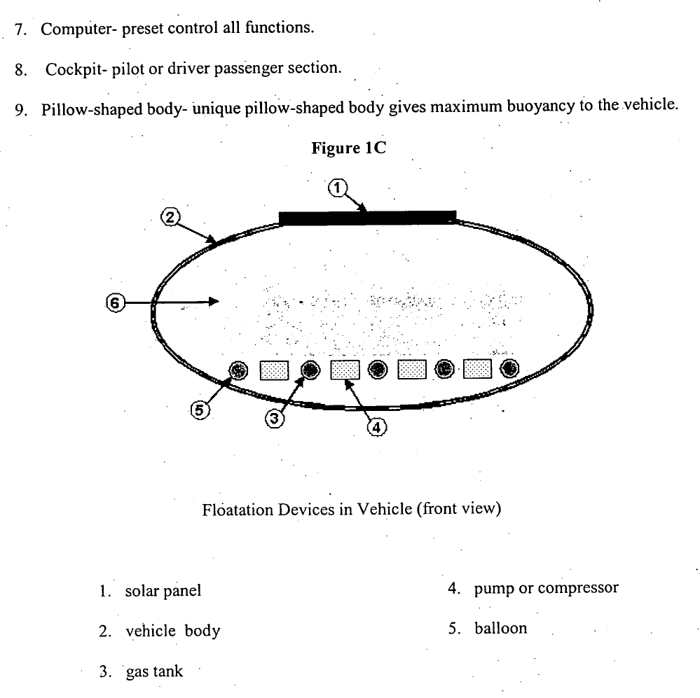

In FIG. 1, we see a side view of the floatation device installed in a specially designed vehicle. As indicated in no. 2, the entire fuselage is a rectangular pillow-shaped body; made entirely of super strong and super light carbon fiber composite material. The entire roof of the body is covered by solar cells, indicated in no. 2, which will be able to receive enough sunlight throughout the day to power the entire electrical requirement of the vehicle. No. 3 shows the specially designed lightweight storage batteries where excess electrical energy generated during the day can be stored, and this stored energy can be used during nighttime operation. No. 4 shows the pump or compressor unit that will pump helium gas in and out of the balloons to inflate or deflate them as required. No. 7 indicates the computer that will control the entire complicated operation of the system. No. 8 is the section where the pilot/operator, passengers and cargo are located. The upper tail section of the vehicle is where the electric motor propellers, powered by the electricity generated by solar energy, is located; these will be used to drive the vehicle forward. No. 5 indicates the helium gas cylinder, where the helium gas is stored for use and reuse. No. 6 shows where the multiple pre-shaped and prearranged balloons are positioned. Below the vehicle are a couple of hundred balloons that will form the support of the vehicle when it is on the ground.

The way the whole floatation device works is based on the principle of balloon buoyancy. The entire floatation device is actually a huge balloon. But instead of using one single balloon as in a usual airship, it is composed of multiple balloons, formed inside a super strong and super light body shell. The use of solar energy totally eliminates the need for fossil fuel, the engine drive and other equipment that make up for most of the weight of an airplane. The rectangular pillow-shaped body gives buoyancy, and more bulk and space for additional balloons to carry more helium gas. It also allows for the layout of so many solar cells on the roof of the vehicle that will generate more than enough power for its own needs. The rectangular pillow-shaped body also has an aerodynamic design, allowing the vehicle to knife thru the air with the least amount of air resistance. The flat smooth bottom of the vehicle also gives stability and maximum buoyancy as it moves forward.

The floatation device, once engaged, uses power supplied by the solar cell to start the pumps or compressors to pump helium gas from the storage cylinder into the balloons. Once the balloons are filled as desired, the entire fuselage body will begin to rise up the air, like any ordinary balloon will. When the vehicle has risen to the desired height, then the pilot/operator of the vehicle shall make use of the surplus electricity to engage the electric motor propellers and fly the vehicle like an ordinary airplane. Once the pilot/operator has reached his destination, he shall then reverse the whole process by gradually pumping the helium gas back to the gas storage cylinder. The vehicle shall then slowly and safely float back to the ground. The pilot/operator can repeat the whole process thousands of times, without the danger and difficulty accompanying the landing of an airplane. Helium is an inert gas and therefore not combustible, so it is safe as well.

The buoyancy of the vehicle can be calculated by comparing the entire weight of the vehicle against the lifting power of the total combined volume of helium gas balloons or balloons that will be contained in the vehicle. Obviously, this project was totally impossible in our immediate past. But with today's advances in technology, especially with regards to building materials and computers, this project can now be a reality.

What we claim as our invention is:

1-3. (canceled)

4. A solar-powered floatation device comprising of:
a. A rectangular pillow-shaped body made of carbon fiber material containing multiple pre-shaped and pre-arranged inflatable air bags and a compressed helium gas storage container, reversible compressors or pumps and storage batteries.
b. A system of arrays of solar panel that cover the entire roof of the body to produce the electrical power needed to run the devices.
c. A computer system to regulate the amount of helium gas that will be pumped into the pre-shaped and pre-arranged balloons/ballasts to inflate or deflate them thru preset programming to allow the entire body to become weightless.

5. The solar-powered floatation device of claim 1 wherein said body will be made of the latest super-thin, super-lightweight and super-strong carbon fiber material, and which must be rectangular and pillow-shaped to achieve maximum buoyancy.

6. The solar-powered floatation device of claim 1 wherein said pre-shaped and pre-arranged airbags are made of durable weather-proof, puncture-proof material.

7. The solar-powered floatation device of claim 1 wherein said compressed helium gas storage containers are made of super-strong and super-lightweight material, and are small and compact.

8. The solar-powered floatation device of claim 1 wherein said reversible compressors or pumps are made of super-strong and super-lightweight material, and are small and compact.

9. The solar-powered floatation device of claim 1 wherein the storage batteries are made of super-strong and super-lightweight material.

10. The solar-powered floatation device of claim 2 wherein said array of solar panels are made of the latest high electricity-generating panels available.

11. The solar-powered floatation device of claim 2 wherein the most efficient and most lightweight energy conversion system of solar to electrical energy is used.

12. The solar-powered floatation device of claim 3 wherein a computer is used to control the compressors or pumps to inflate or deflate the number of airbags needed as determined by a preset program.

13. The solar-powered floatation device of claim 3 wherein a computer is used to control the electrical system needed to run the entire device.

14. The solar-powered floatation device includes a set of propellers attached outside the body of the device powered by electrical motor to give forward and backward movements.
The Solar Powered Floatation Device shall include fins, a stabilizer and other navigating devices common to flying machines that shall give its pilot control once it is floating in the air.
